(19) United States
(12) Patent Application Publication
(10) Pub. No.: US 2004/0219085 A1
(43) Pub. Date: Nov. 4, 2004

(54) Thermal oxidation decomposition type detoxifying method and apparatus for exhaust gas

(75) Inventor: Masanobu Ogawa, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/781,774

(22) Filed: Feb. 20, 2004

(30) Foreign Application Priority Data
Feb. 21, 2003 (JP) 2003-44214

(51) Int. Cl. B01D 53/70; B01J 8/04; F28D 1/00

(52) U.S. Cl. 423/240 R; 422/188; 422/189; 422/198

(57) ABSTRACT

A thermal oxidation decomposition type detoxifying apparatus for an exhaust gas comprises: an exhaust gas introducing conduit to introduce exhaust gas; a reactive unit to which said exhaust gas introducing conduit being connected and having a first reactive chamber kept at a first temperature and a second reactive chamber kept at a second temperature different from the first temperature, said second reactive chamber being disposed in downstream of and adjoined on said first reactive chamber; an oxidizing gas source adapted to supply an oxidizing gas into said first reactive chamber, said oxidizing gas undergoing thermal oxidation decomposition of said exhaust gas; a neutralizing gas source adapted to supply a neutralizing gas into said second reactive chamber, said neutralizing gas neutralizing a gas generated by the thermal oxidation decomposition; and a discharging unit to discharge a processed exhaust gas processed in said reactive unit.

A thermal oxidation decomposition type detoxifying method for an exhaust gas, comprises: introducing an exhaust gas in a reactive unit having a first reactive chamber kept at a first temperature and a second reactive chamber kept at a second temperature different from the first temperature, said second reactive chamber being disposed in downstream of and adjoined on said first reactive chamber; supplying an oxidizing gas into said first reactive chamber, said oxidizing gas undergoing thermal oxidation decomposition of said exhaust gas; supplying a neutralizing gas into said second reactive chamber, said neutralizing gas neutralizing a gas generated by the thermal oxidation decomposition; and discharging a processed exhaust gas processed in said reactive unit to exterior of the reactive unit.

### CROSS REFERENCE TO RELATED APPLICATIONS

This application is based upon and claims the benefit of priority from the prior Japanese Patent Application No. 2003-044214, filed on Feb. 21, 2003; the entire contents of which are incorporated herein by reference.

### BACKGROUND OF THE INVENTION

The present invention relates to a thermal oxidation decomposition type detoxifying method and apparatus for an exhaust gas discharged during, e.g., a CVD (Chemical Vapor Deposition) step in a semiconductor device manufacturing process.

As known well, for instance in the semiconductor device manufacturing process, steps of CVD, etching and so on involve using a PFC (Poly Fluoro-Chloride) gas of SiH₄, C₂F₆, CF₄, etc. Then, these gases are discharged as exhaust gases during this step. Therefore, these exhaust gases are treated and purged of harmful substances by the detoxifying apparatus, and then discharged after this step.

Constructions of this type of conventional detoxifying apparatus will be explained referring to FIGS. 2 through 4. Note that FIG. 2 is a view of a system configuration of the detoxifying apparatus for the SiH₄ exhaust gas, FIG. 3 is a view of a system configuration of the detoxifying apparatus for the PFC exhaust gas, and FIG. 4 is a view of a system configuration of the detoxifying apparatus for an SiH₄/PFC exhaust gas.

Referring first to FIG. 2, a water reservoir 3 is provided at a lower portion of an apparatus main body 2 of a detoxifying apparatus 1 for the SiH₄ exhaust gas, and an upper portion thereof is provided with an exhaust gas introducing chamber 4, a reactive unit 5 and an exhaust gas discharge chamber 6. These exhaust gas introducing chamber 4, reactive unit 5 and exhaust gas discharge chamber 6 are opened at their lower parts to an upper air space 7 within the water reservoir 3.

The exhaust gas introducing chamber 4 is provided at its upper part with an exhaust gas introducing port 8. This exhaust gas introducing port 8 is connected to an exhaust gas source 9 of the SiH₄ exhaust gas via an exhaust gas introducing conduit 10. Further, a nitrogen gas supply conduit 11 is connected to a middle part of the exhaust gas introducing conduit 10, wherein a nitrogen gas from a nitrogen gas source 12 is mixed with the SiH₄ exhaust gas, and the mixed gas is introduced into the exhaust gas introducing chamber 4. Moreover, the exhaust gas introducing chamber 4 is provided with a first water shower 13 for purging the gas of a dust matter such as coarse particulate (dust) by spraying the shower-like water to the mixed gas flowing downwards along an internal flow path from the exhaust gas introducing port 8 provided upwards, and for washing them away into the water reservoir 3.

With this arrangement, the exhaust gas, which has been supplied in a state of being mixed with the nitrogen gas from the exhaust gas introducing port 8 into the exhaust gas introducing chamber 4, flows downwards while being midways sprayed with the shower-like water and reaches an upstream-side air space 7a of the upper air space 7 within the water reservoir 3.

Further, the reactive unit 5 is provided with a partition wall 14 for partitioning the lower part opened to the upper air space 7 within the water reservoir 3 and an interior of the reactive unit 5 to form an upstream chamber 5a on the side of the exhaust gas introducing chamber 4 and a downstream chamber 5b on the side of the exhaust gas discharge chamber 6, this partition wall 14 extending upwards from within the water in the water reservoir 3 so as to form a gas flow reversing unit 15 for reversing a flowing direction of the exhaust gas. Moreover, the reactive unit 5 is provided with an oxidizing gas supply chamber 16 for supplying the air as an oxidizing gas into the upstream chamber 5b and the downstream chamber 5b as well. This oxidizing gas supply chamber 16 can be supplied with the air from an air source 18 via an oxidizing gas supply conduit 17. Still further, each of the upstream chamber 5a and the downstream chamber 5b of the reactive chamber 5 includes a heater 19 for keeping the interior of each of the chambers 5a, 5b at a temperature equal to or higher than 600° C. which is a predetermined temperature of required for a thermal oxidation decomposition of the exhaust gas of SiH₄, e.g. 700° C. Note that the heater 19 is held by a holding unit 20 therefor.

With this arrangement, the exhaust gas, which has flowed into the upstream chamber 5a of the reactive unit 5 via the upstream-side air space 7a within the water reservoir 3 from the exhaust gas introducing chamber 4, further flows upwards along the internal flow path within the upstream chamber 5a and reaches the gas flow reversing unit 15. The exhaust gas further flows therefrom downwards along the internal flow path within the downstream chamber 5b into the downstream-side air space 7b of the upper air space 7 within the water reservoir 3. Then, the exhaust gas, during the flow through within the upstream chamber 5a and within the downstream chamber 5b while being kept at the predetermined temperature, undergoes the thermal oxidation decomposition by oxygen contained in the air supplied.

Moreover, the exhaust gas discharge chamber 6 is provided at its upper part with an exhaust gas discharge port 21. An exhaust scrubber 23 opened to the atmosphere on its discharge side is connected via an exhaust gas discharge conduit 24 to the exhaust gas discharge port 21 in a way that provides an exhaust fan 22 therebetween.

Furthermore, the exhaust gas discharge chamber 6 is provided with a second water shower 25 for purging the gas of a dust, e.g., SiO₂, etc. generated from the thermal oxidation by spraying the shower-like water to the exhaust gas flowing upwards from the upper air space 7 within the water reservoir 3 along the internal flow path towards the upper exhaust gas discharge port 21, and for washing it away into the water reservoir 3.

With this arrangement, the exhaust gas after undergoing the thermal oxidation decomposition, which has flowed into the lower part of the exhaust gas discharge chamber 6 via the downstream-side air space 7b within the water reservoir 3 from the downstream chamber 5b of the reactive unit 5, flows upwards while being sprayed with the shower-like water midways, and further flows to the upper exhaust gas discharge port 21. Then, the exhaust gas is sent to the exhaust scrubber 23 via the exhaust gas discharge conduit 24 from the exhaust gas discharge port 21 by the exhaust fan 22, and discharged into the atmosphere outside the apparatus.

Note that in the second water shower 25, the reserved water in the water reservoir 3 is utilized in circulation by providing a circulation path 28 configured by a circulation pump 26 and a water conduit 27. It should be also noted that the reserved water in the water reservoir 3 is kept at a predetermined water level always by a fixed water level mechanism 29, and the reserved water flowing out over the fixed water level is to be reserved in a acid water discharger 30. Further, the reserved water in the water reservoir 3 can be also flowed out into the acid water discharger 30 via a waster discharge conduit 32 provided with a valve 31.

On the other hand, referring to FIG. 3, the reference numeral 35 represents a detoxifying apparatus for processing the PFC exhaust gas of C₂F₆, CF₄, etc. This detoxifying apparatus 35 has substantially the same construction as the detoxifying apparatus 1 for the SiH₄ exhaust gas has, and the water reservoir 3 is provided at the lower part of an apparatus main body 36 of the detoxifying apparatus 35. Moreover, the detoxifying apparatus 35 is provided at its upper part with an exhaust gas introducing chamber 37, a reactive unit 38 and an exhaust gas discharge chamber 6. These exhaust gas introducing chamber 37, reactive unit 38 and exhaust gas discharge chamber 6 are opened at their lower parts to the upper air space 7 within the water reservoir 3.

In the exhaust gas introducing chamber 37, the exhaust gas introducing port 8 is connected to the exhaust gas source 9 of the PFC exhaust gas via the exhaust gas introducing conduit 10. Further, a nitrogen gas is introduced into a middle part of the exhaust gas introducing conduit 10 via the nitrogen gas supply conduit 11, wherein a mixed gas of the PFC exhaust gas from the exhaust gas source 39 and the nitrogen gas is introduced into the exhaust gas introducing chamber 37 from the exhaust gas introducing port 8. Moreover, the exhaust gas introducing chamber 37 is provided with a neutralizing gas introducing unit 40 for introducing an NH₃ gas as a neutralizing gas into the internal flow path disposed downstream of the first water shower 13, whereby the exhaust gas after being purged of the dust flows as it is mixed with the NH₃ gas coming via a neutralizing gas supply conduit 42 from a neutralizing gas source 41.

With this arrangement, the exhaust gas, which has been supplied in a state of being mixed with the nitrogen gas to the exhaust gas introducing chamber 4 from the exhaust gas introducing port 8, flows downwards while being sprayed with the shower-like water midways and further flows, it being mixed with the NH₃ gas, to the upstream-side air space 7a of the upper air space 7 within the water reservoir 3.

Moreover, the reactive unit 38 is sectioned so that the lower part opened to the upper air space 7 within the water reservoir 3 and an interior of the reactive unit 38 are partitioned by the partition wall 14 to form an upstream chamber 38a on the side of the exhaust gas introducing chamber 37 and a downstream chamber 38b on the side of the exhaust gas discharge chamber 6. Furthermore, the air can be supplied from the oxidizing gas supply chamber 16 into the upstream chamber 38a and the downstream chamber 38b. Still further, each of the upstream chamber 38a and the downstream chamber 38b of the reactive chamber 5 includes a heater 43 for keeping the interior of each of the chambers 38a, 38b at a predetermined, e.g., 1200° C. required for a thermal oxidation decomposition of the PFC exhaust gas because of being equal to or higher than 1000° C. in the case of C₂F₆ and equal to or higher than 1100° C. in the case of CF₄.

With this arrangement, the exhaust gas, which has flowed into the upstream chamber 38a of the reactive unit 38 via the upstream-side air space 7a within the water reservoir 3 from the exhaust gas introducing chamber 37, further flows upwards along the internal flow path within the upstream chamber 38a and reaches the gas flow reversing unit 15. The exhaust gas further flows therefrom downwards along the internal flow path within the downstream chamber 38b into the downstream-side air space 7b of the upper air space 7 within the water reservoir 3. Then, the exhaust gas, during the flow through within the upstream chamber 38a and within the downstream chamber 38b while being kept at the predetermined temperature, undergoes the thermal oxidation decomposition by oxygen contained in the air supplied, with the result that CO₂ and HF are produced. HF is neutralized with NH₃, thereby generating NH₄F. Note that if the thermal oxidation decomposition is not perfect at this time, CO is produced.

Moreover, in the exhaust gas discharge chamber 6 have the same configuration as that of the detoxifying apparatus 1 for the SiH₄ exhaust gas, the exhaust gas after undergoing the thermal oxidation decomposition flows into the lower part via the downstream-side air space 7b within the water reservoir 3 from the downstream chamber 38b of the reactive unit 38, and flows upwards within the exhaust gas discharge chamber 6. Further, at this time, NH₄F contained in the exhaust gas, which has been generated from the thermal oxidation decomposition and the neutralization, is washed away into the water reservoir 3 while being solved with the water from the second water shower 25, thus purging the exhaust gas of NH₄F.

Thereafter, the exhaust gas flows to the upper exhaust gas discharge port 21 and is set to the exhaust scrubber 23 via the exhaust gas discharge conduit 24 by the exhaust fan 22, thereby discharging the exhaust gas into the atmosphere outside the apparatus.

Each of the detoxifying apparatuses 1, 35 is, however, capable of performing nothing other than processing respectively the SiH₄ exhaust gas and the PFC exhaust gas of C₂F₆, CF₄, etc. In the case of both of the SiH₄ exhaust gas utilized in the CVD apparatus and the PFC exhaust gas of C₂F₆, CF₄, etc., as shown in FIG. 4, it was required that the two detoxifying apparatuses 1, 35 be connected in series in the flowing direction of the exhaust gas with respect to the exhaust gas source 45 of the SiH₄ exhaust gas and the PFC exhaust gas of C₂F₆, CF₄, etc., and the exhaust gas source 45 be connected to the exhaust gas introducing port 8 of the detoxifying apparatus 1 for the SiH₄ exhaust gas, at first SiH₄ contained in the exhaust gas be detoxified by the thermal oxidation decomposition, and thereafter PFC be subjected to the thermal oxidation decomposition and detoxified by the detoxifying apparatus 35 for the PFC exhaust gas.

Namely, when performing the process of detoxifying the SiH₄ exhaust gas, in the case of effecting the thermal oxidation decomposition at a temperature equal to or higher than 1000° C., a particle size of the dust produced becomes minute and fine enough to penetrate the water shower without being obstructed, with the result that a sufficient process is unable to be done. Therefore, on the occasion of the process of the SiH₄ exhaust gas, the decomposition must be conducted at the temperature equal to or lower than 700° C., and the apparatus for executing the thermal oxidation decompositions of the SiH₄ exhaust gas and the PFC exhaust gas respectively under different heating conditions, are required.

### SUMMARY OF THE INVENTION

According to one aspect of the present invention, there is provided a thermal oxidation decomposition type detoxifying apparatus for an exhaust gas, comprising:

an exhaust gas introducing conduit to introduce exhaust gas;

a reactive unit to which said exhaust gas introducing conduit being connected and having a first reactive chamber kept at a first temperature and a second reactive chamber kept at a second temperature different from the first temperature, said second reactive chamber being disposed in downstream of and adjoined on said first reactive chamber;

an oxidizing gas source adapted to supply an oxidizing gas into said first reactive chamber, said oxidizing gas undergoing thermal oxidation decomposition of said exhaust gas;

a neutralizing gas source adapted to supply a neutralizing gas into said second reactive chamber, said neutralizing gas neutralizing a gas generated by the thermal oxidation decomposition; and

a discharging unit to discharge a processed exhaust gas processed in said reactive unit.

According to another aspect of the present invention, there is provided a thermal oxidation decomposition type detoxifying method for an exhaust gas, comprising: introducing an exhaust gas in a reactive unit having a first reactive chamber kept at a first temperature and a second reactive chamber kept at a second temperature different from the first temperature, said second reactive chamber being disposed in downstream of and adjoined on said first reactive chamber; supplying an oxidizing gas into said first reactive chamber, said oxidizing gas undergoing thermal oxidation decomposition of said exhaust gas; supplying a neutralizing gas into said second reactive chamber, said neutralizing gas neutralizing a gas generated by the thermal oxidation decomposition; and discharging a processed exhaust gas processed in said reactive unit to exterior of the reactive unit.

### BRIEF DESCRIPTION OF THE DRAWINGS

FIG. 1 is a view of a system configuration of a detoxifying apparatus for SiH₄ and PFC exhaust gases, illustrating one embodiment of the present invention;

FIG. 2 is a view of a system configuration of a detoxifying apparatus for a SiH₄ exhaust gas in the prior art;

FIG. 3 is a view of a system configuration of a detoxifying apparatus for a PFC exhaust gas in the prior art; and

FIG. 4 is a view of architectures of the detoxifying apparatuses for the SiH₄ and PFC exhaust gases in the prior art.

### DETAILED DESCRIPTION OF THE INVENTION

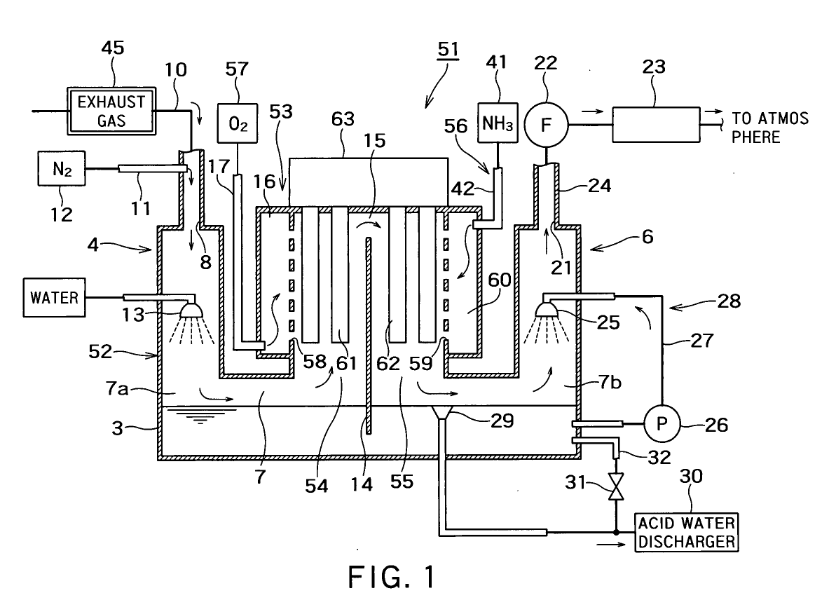

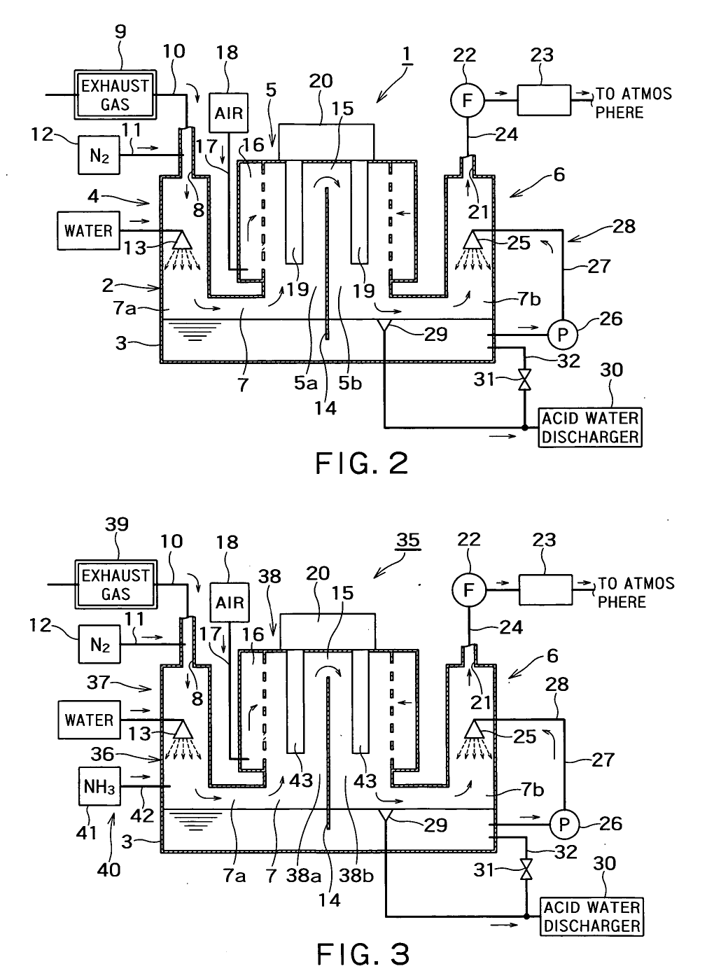

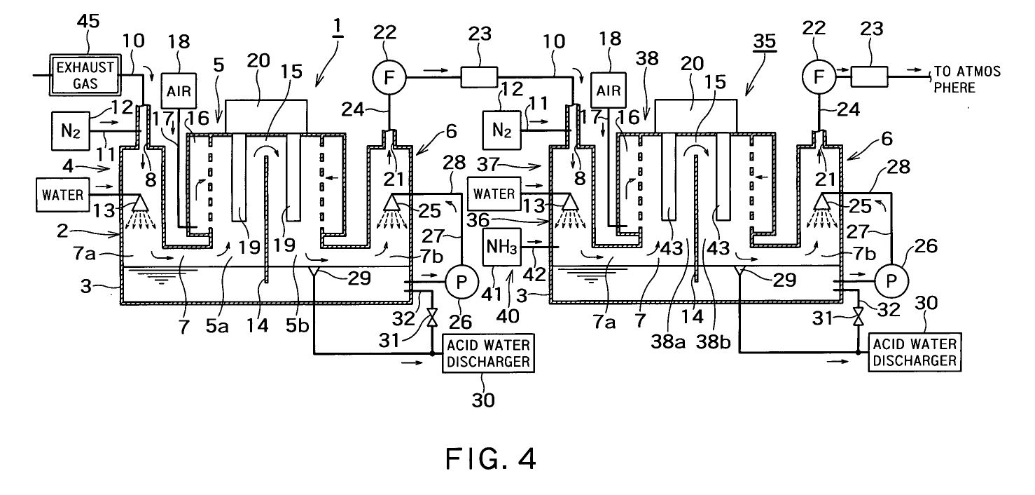

One embodiment of the present invention will hereinafter be described with reference to FIG. 1. FIG. 1 shows a view of a system configuration of a detoxifying apparatus for SiH₄ and PCF exhaust gases. Note that the same components as those in the prior art are marked with the same reference numerals in a way that omits their repetitive explanations, and the discussion will be focused on a system configuration of the present invention that is different from the prior art.

Referring to FIG. 1, the reference numeral 51 designates a detoxifying apparatus for the SiH₄ and PFC exhaust gases. A water reservoir 3 is provided at a lower portion of an apparatus main body 52 of the detoxifying apparatus 51, and an upper portion thereof is provided with an exhaust gas introducing chamber 4, a reactive unit 53 and an exhaust gas discharge chamber 6. These exhaust gas introducing chamber 4, reactive unit 53 and exhaust gas discharge chamber 6 are opened at their lower parts to an upper air space 7 within the water reservoir 3.

The exhaust gas introducing chamber 4 is provided at its upper part with an exhaust gas introducing port 8. This exhaust gas introducing port 8 is connected to an exhaust gas source 44 of the SiH₄ exhaust gas and the PFC exhaust gas of C₂F₆, CF₄, etc. via an exhaust gas introducing conduit 10. Further, a nitrogen gas supply conduit 11 is connected to a middle part of the exhaust gas introducing conduit 10, wherein a mixed exhaust gas of the SiH₄ exhaust gas and the PFC exhaust gas of C₂F₆, CF₄, etc. which come from the exhaust gas source 45 is further mixed with a nitrogen gas coming from a nitrogen gas source 12, and this mixed gas is introduced into the exhaust gas introducing chamber 4. Moreover, the exhaust gas introducing chamber 4 is provided with a first water shower 13 for purging the mixed gas of a dust matter such as coarse particulate that flows downwards along an internal flow path.

With this arrangement, the exhaust gas, which has been supplied in a state of being mixed with the nitrogen gas from the exhaust gas introducing port 8 into the exhaust gas introducing chamber 4, flows to an upstream-side air space 7a within the water reservoir 3 while being midways sprayed with the shower-like water.

Further, the reactive unit 53 is provided with a partition wall 14 for partitioning the lower part opened to the upper air space 7 within the water reservoir 3 into an upstream-side area and a downstream-side area and for forming a gas flow reversing unit 15 for reversing a flowing direction of the exhaust gas at an upper part within the reactive unit 53, this partition wall 14 extending upwards from within the water in the water reservoir 3, whereby a first reactive chamber 54 as the upstream-side area on the side of the exhaust gas introducing chamber 4 and a second reactive chamber 55 as the downstream-side area on the side of the exhaust gas discharge chamber 6. Moreover, the reactive unit 53 is provided with an oxidizing gas supply chamber 16 for supplying oxygen in the oxidizing gas to interiors of the first reactive chamber 54 and of the second reactive chamber 55. Still further, the reactive unit 53 is provided with a neutralizing gas introducing unit 56 for supplying NH₃ in the neutralizing gas into the reactive chamber 55.

The oxidizing gas supply chamber 16 can be supplied with the oxygen from an oxygen source 57 via an oxidizing gas supply conduit 17. Then, the oxygen supplied to the oxidizing gas supply chamber 16 is further supplied into the first reactive chamber 54 from a first supply hole 58 formed in a side wall between the oxidizing gas supply chamber 16 and the first reactive chamber 54, and also flows and is thus supplied to the second reactive chamber 55 via the gas flow reversing unit 15. On the other hand, the neutralizing gas introducing unit 56 includes a neutralizing gas supply chamber 60 in a way that provides a side wall formed with a second supply hole 59 between the second reactive chamber 55 and the neutralizing gas supply chamber 60. A NH₃ gas is supplied from a neutralizing gas source 41 into the neutralizing gas supply chamber 60 via a neutralizing gas supply conduit 42 and further supplied into the second reactive chamber 55 from the second supply hole 59.

Moreover, the first reactive chamber 54 and the second reactive chamber 55 have bar-shaped first and second heaters 61, 62 hung from ceiling portions of the respective reactive chambers 54, 55. Note that the reference numeral 63 denotes a holding member for each of the two heaters 61, 62. Then, the first heater 61 is electrified, thereby keeping the interior of the first reactive chamber 54 at a first predetermined temperature of 600° C. through 700° C., e.g., 700° C. required for performing the thermal oxidation decomposition of SiH₄ contained in the exhaust gas. Further, the second heater 62 is electrified, thereby keeping the interior of the second reactive chamber 54 at a second predetermined temperature equal to or higher than, e.g. 1200° C. required for performing the thermal oxidation decomposition of PFC exhaust gas contained in the exhaust gas because of being equal to or higher than 1000° C. in the case of C₂F₆ and equal to or higher than 1100° C. in the case of CF₄.

With this arrangement, the exhaust gas, which has flowed into the first reactive chamber 54 of the reactive unit 53 via the upstream-side air space 7a within the water reservoir 3 from the exhaust gas introducing chamber 4, flows upwards along the internal flow path within the first reactive chamber 54 kept at the first temperature, e.g., 700° C. During this flow, SiH₄ contained in the exhaust gas undergoes the thermal oxidation decomposition, thereby generating SiO₂ and H₂O. Further, a reaction formula in this case is given below.

2SiH₄+3O₂→2SiO₂+2H₂O (600° C. or higher)

Subsequently, the exhaust gas, which has flowed into the second reactive chamber 55 from the gas flow reversing unit 15, flows downwards along the internal flow path within the second reactive chamber 55 kept at the second temperature equal to or higher than, e.g., 1200° C. During this flow, the PFC gas contained in the exhaust gas undergoes the thermal oxidation decomposition, thereby generating CO₂ and HF. Moreover, HF generated from the thermal oxidation decomposition of the PFC gas is neutralized with the NH₃ gas supplied into the second reactive chamber 55 from the neutralizing gas source 41, thereby producing NH₄F. Thereafter, the exhaust gas flows to the downstream-side air space 7b of the upper air space 7 within the water reservoir 3.

Note that at first with respect to the water produced from the thermal oxidation decomposition SiH₄, a reaction formula in the second reactive chamber 55 is given by:

2H₂O→2H₂+O₂ (1000° C. or higher)

a reaction formula in a case where the PFC gas is C₂F₆ is given by:

C₂F₆+3H₂+2O₂→2CO₂+6HF (1000° C. or higher) and

a reaction formula in a case where the PFC gas is CF₄ is given by:

CF₄+2H₂+O₂→CO₂+4HF (1100° C. or higher)

then, in any case a reaction formula with respect to the neutralization of HF generated is given such as:

HF+NH3→NF₄F

Moreover, the exhaust gas discharge chamber 6 is provided at its upper part with an exhaust gas discharge port 21, and a middle part of the internal flow path extending from the upper air space 7 within the water reservoir 3 towards the exhaust gas discharge port 21, is provided with a second water shower 25 for spraying the shower-like water to the exhaust gas flowing upwards along the internal flow path. Further, the exhaust gas discharge port 21 is provided with an exhaust fan 22. An exhaust scrubber 23 opened to the atmosphere on the discharge side is connected to this exhaust gas discharge port 21 via a gas discharge conduit 24 into which to insert an unillustrated gas detector for checking, in short, whether the exhaust gas has already been detoxified or not.

With this arrangement, the exhaust gas after undergoing the thermal oxidation decomposition, which has flowed into the lower part of the exhaust gas discharge chamber 6 via the downstream-side air space 7b within the water reservoir 3 from the second reactive chamber 55 of the reactive unit 53, flows upwards along the internal flow path and is, in the meantime, sprayed with the shower-like water from the second water shower 25, whereby the dust of SiO₂, etc. generated from the thermal oxidation decomposition in the first reactive chamber 54 is washed away into the water reservoir 3, and NH₄F generated in the second reactive chamber 55 is washed away while being solved with the water into the water reservoir 3 and is thus removed. Then, the processed exhaust gas that has been purged of the dust such as SiO₂, etc. and NH₄F as well is sent to the exhaust scrubber 23 via the exhaust gas discharge conduit 24 by the exhaust fan 22 from the exhaust gas discharge port 21, and discharged into the atmosphere outside the apparatus.

The configuration made as described above enables, in the case of processing the exhaust mixed gas of the SiH₄ exhaust gas and the PFC exhaust gas of C₂F₆, CF₄, etc., the detoxifying process to be executed with one single apparatus. This configuration also makes it possible to surely effect the detoxifying process at one time without causing a rise in costs for the process (detoxifying) apparatuses such as connecting in series the detoxifying apparatuses for respective types of exhaust gases, i.e., the detoxifying apparatus for the SiH₄ exhaust gas and the detoxifying apparatus for the PFC exhaust gas.

Moreover, on the occasion of the detoxifying process, in regards to the dust, viz., SiO₂ produced by processing the SiH₄ exhaust gas, its particle size remains unchanged even at 1200° C. or higher. Hence, at first, the particle size of SiO₂ produced by processing the SiH₄ exhaust gas at the predetermined temperature equal to or lower than 700° C. can stay unreduced, and further the PFC exhaust gas is treated afterward at the predetermined temperature equal to higher than 1200° C., whereby the particle size of SiO₂ does not decrease on this occasion, and SiO₂ can be removed by the second water shower without being discharged outside the apparatus.

Moreover, NH4F, generated from the thermal oxidation decomposition, of the PFC exhaust gas is removed by the second water shower 25 without being discharged outside the apparatus, and oxygen is supplied as the oxidizing gas. It is therefore feasible to conduct the perfect thermal oxidation decomposition of the PFC exhaust gas and to restrain the generation of poisonous CO produced from the imperfect thermal oxidation decomposition.

As obvious from the discussion made so far, the present invention exhibits the effects wherein the one single apparatus can perform the perfect thermal oxidation decomposition of the two types of exhaust gases, e.g., the SiH₄ exhaust gas and the PFC exhaust gas in a way that restrains the generation of CO, and is capable of the detoxification by surely executing the process at one time, and so on.

What is claimed is:

1. A thermal oxidation decomposition type detoxifying apparatus for an exhaust gas, comprising:
an exhaust gas introducing conduit to introduce exhaust gas;
a reactive unit to which said exhaust gas introducing conduit being connected and having a first reactive chamber kept at a first temperature and a second reactive chamber kept at a second temperature different from the first temperature, said second reactive chamber being disposed in downstream of and adjoined on said first reactive chamber;
an oxidizing gas source adapted to supply an oxidizing gas into said first reactive chamber, said oxidizing gas undergoing thermal oxidation decomposition of said exhaust gas;
a neutralizing gas source adapted to supply a neutralizing gas into said second reactive chamber, said neutralizing gas neutralizing a gas generated by the thermal oxidation decomposition; and
a discharging unit to discharge a processed exhaust gas processed in said reactive unit to exterior of the apparatus.

2. The thermal oxidation decomposition type detoxifying apparatus for an exhaust gas according to claim 1, wherein the exhaust gas is a mixed exhaust gas of SiH₄ and a PFC gas, the oxidizing gas is oxygen, and the neutralizing gas is NH₃ gas.

3. The thermal oxidation decomposition type detoxifying apparatus for an exhaust gas according to claim 2, wherein said PFC gas is one selected from C₂F₆, CF₄, etc.

4. The thermal oxidation decomposition type detoxifying apparatus for an exhaust gas according to claim 1, further comprising a mixing unit to obtain a mixed gas by mixing nitrogen gas into said exhaust gas, said mixing unit being disposed upstream side of said first reactive chamber.

5. The thermal oxidation decomposition type detoxifying apparatus for an exhaust gas according to claim 1, wherein the first temperature is set at 600° C. through 700° C., ad the second temperature is set at 1100°c or higher.

6. The thermal oxidation decomposition type detoxifying apparatus for an exhaust gas according to claim 1, wherein a first water shower is provided in the flow path of the exhaust gas in the upstream of said first reactive chamber.

7. The thermal oxidation decomposition type detoxifying apparatus for an exhaust gas according to claim 1, wherein a second water shower is provided in the flow path of the exhaust gas in the downstream of the second reactive chamber.

8. A thermal oxidation decomposition type detoxifying method for an exhaust gas, comprising:
introducing an exhaust gas in a reactive unit having a first reactive chamber kept at a first temperature and a second reactive chamber kept at a second temperature different from the first temperature, said second reactive chamber being disposed in downstream of and adjoined on said first reactive chamber;
supplying an oxidizing gas into said first reactive chamber, said oxidizing gas undergoing thermal oxidation decomposition of said exhaust gas;
supplying a neutralizing gas into said second reactive chamber, said neutralizing gas neutralizing a gas generated by the thermal oxidation decomposition; and
discharging a processed exhaust gas processed in said reactive unit to exterior of the reactive unit.

9. The thermal oxidation decomposition type detoxifying method for an exhaust gas according to claim 8, wherein the exhaust gas is a mixed exhaust gas of SiH₄ and a PFC gas, the oxidizing gas is oxygen, and the neutralizing gas is NH₃ gas.

10. The thermal oxidation decomposition type detoxifying apparatus for an exhaust gas according to claim 8, wherein said PFC gas is one selected from C₂F₆, CF₄, etc.

11. The thermal oxidation decomposition type detoxifying method for an exhaust gas according to claim 8, further comprising mixing nitrogen gas into said exhaust gas in the upstream side of said first reactive chamber.

12. The thermal oxidation decomposition type detoxifying method for an exhaust gas according to claim 8, wherein the first temperature is set at 600° C. through 700° C., ad the second temperature is set at 1100°c or higher.

13. The thermal oxidation decomposition type detoxifying method for an exhaust gas according to claim 8, further comprising passing the exhaust gas in a first water shower in the flow path of the exhaust gas at the upstream of said first reactive chamber.

14. The thermal oxidation decomposition type detoxifying method for an exhaust gas according to claim 13, further comprising passing the processed exhaust gas in a second water shower in the flow path of the exhaust gas in the downstream of the second reactive chamber.
